(19) United States
(12) Patent Application Publication
(10) Pub. No.: US 2007/0055791 A1
(43) Pub. Date: Mar. 8, 2007

(54) Integrated power converter and I/O expansion

(76) Inventors: Steve Wood, Boise, ID (US); Charles Mollo, Phoenix, AZ (US)

Correspondence Address: JACKSON WALKER LLP, 901 MAIN STREET, SUITE 6000, DALLAS, TX, 75202-3797, US

(21) Appl. No.: 11/209,979

(22) Filed: Aug. 23, 2005

(51) Int. Cl. G06F 3/00

(52) U.S. Cl. 710/2

(57) ABSTRACT

An integrated power converter and input/output (I/O) port configured to provide power for a portable electronic device, and also interface data communications to the portable electronic device.

### FIELD OF THE INVENTION

The present invention is generally related to power converters, and more particularly to programmable power converters adapted to power a variety of different portable electronic devices.

### BACKGROUND OF THE INVENTION

Power converters are well known and are utilized to power a variety of portable electronic devices, including notebook computers, PDA's, cell phones, digital cameras, gaming devices, MP3 players and so forth. Programmable power converters are universal devices having programmable output voltages and/or currents to meet the needs of different portable electronic devices. One type of universal programmable power converters is manufactured by Mobility Electronics, Inc. of Scottsdale Ariz., the Applicant of the present invention. Such converters include interchangeable tips which may be utilized with a single AC/DC, DC/DC, and AC/DC Combo power converter to program the output voltage/current generated by the power converter, and also provide a suitable mechanical fit to the portable electronic device to be powered.

There is desired an improved power converter device that is suitable to meet other needs of portable electronic devices, particularly as these portable electronic devices become more functional and more complex.

### SUMMARY OF INVENTION

The present invention achieves technical advantages as an integrated power converter and input/output (I/O) device configured to provide both programmable power for a portable electronic device, and also interface data communications to the portable electronic device.

The device may include I/O expansion electronics adapted to receive data communications, and forward the data communications to the portable electronic device. This integrated solution provides a universal solution for providing both power and data communications to a portable electronic device. The I/O electronics may take the form of an expansion card selectively attachable to a housing, which housing may be coupled to, or enclose, the power converter electronics. A single output cord carrying both power and data communications may be provided, such as with universal tips to provide both electrical and mechanical connections to a portable electronic device.

### BRIEF DESCRIPTION OF THE DRAWINGS

FIG. 1 is a block diagram of an integrated power converter and data communication connectivity device according to one embodiment of the present invention: and

FIG. 2 is a diagram of a cable interconnecting the housing to portable electronic devices.

### DETAILED DESCRIPTION OF THE PRESENT INVENTION

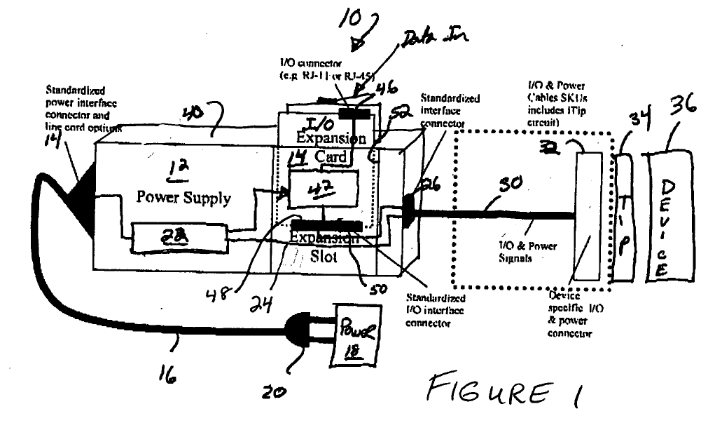

Referring now to FIG. 1, there is shown generally at 10 a universal device seen to include a power converter 12 and an I/O data communication interface 14. The power converter 12 is seen to have an input connector 16 adapted to receive a source of power from a source 18 via a connector 20, which source of power may be an AC or a DC voltage source. Power supply 12 is seen to have power conversion electronics 22 adapted to receive power from connector 14, and provide a programmable output voltage and/or current via output line 24 to an output connector 26.

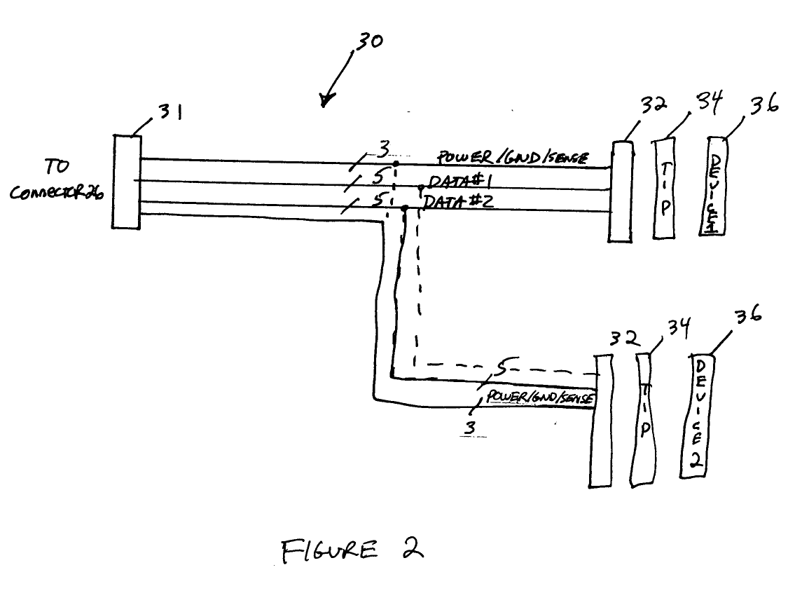

A cable 30 having a plurality of electrical conductors and connector 31 is configured to be selectively coupled to connector 26, and route power signals to a connector 32, which connectors may be a generic or universal connector. A programming device connector 34 may be selectively connected to connector 32, providing an electrical interface from cable 30 to portable electronic device 36 to be powered, and also provide mechanical interconnection thereto. The tip connector 34 may be an iTip™ type connector manufactured by Mobility Electronics, Inc. of Scottsdale Ariz. This interchangeable tip 34 may program the output voltage and/or current of the power supply 12 delivered by electronics 22. The cable 30 may also have more than one set of data conductors for routing data signals to one or more devices 36, as shown in FIG. 2. For instance, the data and/or power conductors may be routed to a common connector 32, or to multiple connectors 32 to communicate with multiple devices 36.

Still referring to FIG. 1, there is shown a data communication interface 14 forming a portion of device 10, which interface 14 may be mechanically coupled to, or contained within, a housing 40 of power supply 12. Interface 14 is shown in one preferred embodiment of the invention to comprise of one or more expansion cards each having integrated therewith respective interface electronic circuitry 42 providing an electrical, protocol and mechanical interface from respective I/O connector 46 to a respective I/O connector 48. Each I/O connector 48 is adapted to be selectively connected to a respective connector 50, the connectors 50 forming a portion of device 10. Each connector 50 is seen to be integrated within the housing 40 enclosing power supply 12 in FIG. 1.

As shown in FIG. 1, power supply housing 40 has one or more expansion slots 52 including the receptacles 50, wherein the receiving connector 50 may be disposed at a lower portion thereof or at another desired location. Advantageously, each I/O expansion card 14 is adapted to be selectively disposed within, and received by, the expansion slot 52. Each I/O circuitry 42 bi-directionally or uni-directionally interfaces data signals between respective I/O connector 46 and respective I/O connector 48, and is configured to provide format and/or data conversion thereof. Among other functionality, the electronic circuitry 42 converts and/or translates the communication protocols used on the external network/device(s) connected to I/O connector 46 and the communication protocols native to the connected portable device(s). The electronic circuitry may also include intelligent power conversion functionality wherein the communication medium supports routing power and data over the physical communication interface. For instance, data communications received at connector 46 may include Ethernet, modem/PSTN connectivity, 802.11 connectivity (and variations thereof), Blue Tooth, and storage/memory card options. When a storage/memory card is utilized, the device 10 functions as solid state storage solution.

Each I/O conversion electronics 42 may be disposed on an interchangeable module, although such electronics may also be disposed within housing 40, or both. In either case, the respective electronics 42 provides the desired data interface and connectivity such that data communications provided to input 46 can ultimately be delivered via respective cable 30 to a respective portable electronic device 36, as shown. Multiple interfaces 14 may be utilized, and the respective signals to/from each being routed over separate cables 30, or collectively over one common cable. Multiple devices 36 may be connected to respective interfaces 14 via the common device 10 as well, such as configured as a data hub including power conversion.

As shown, cable 30 includes a plurality of dedicated electrical conductors, some which are dedicated to communicate power, and other conductors which are configured to communicate the data signals from one or more of the expansion slot connectors 50 to the portable electronics device 36. For instance, five conductors may be reserved for data communications, and two or more conductors may be reserved for power, i.e. positive, negative, sense, and ground if desired. More conductors may be provided to provide additional data lines, such as if more than one interface 14 is utilized to interface multiple data ports to the device 36.

Advantageously, expansion electronics 42 are also seen to be powered by the power converter 12 itself, with power being delivered to electronics 22 of the electronics 42. Hence, only one source of power needs to be provided to the device 10 to power both the power converter 12 and interface 14.

Advantageously, device 10 may be configured to communicate over a variety of networks (e.g. PSTN, Ethernet, PAN, etc.) Configured as a modem, the device 10 enables data/PIM sync between a portable electronic device and a portable computer. Configured as a modem, the device 10 allows the portable electronic device to access the internet. The device 10 may also be configured to enable many other applications over a network, including custom applications. For instance, USB to Ethernet card, USB to Blue Tooth, or to receive a Flash Memory Card. Moreover, program such as custom ringers, may be down loaded from the PC or network via the device 10 to the portable electronic device.

In an alternative embodiment of the invention, a Blue Tooth interface may be integrated with device 10 to communicate the various data signals from the interfaces 14 to the device or devices 36. Thus, device 10 is not limited to hardwiring of data between the interface cards 14 and devices 36.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. A device, comprising:
a housing;
a power converter coupled to the housing and having an input, an output, and power conversion circuitry configured to receive power at the input and provide converted power to the output, the power converter being configured to power a portable electronics device; and
a data input/output (I/O) circuit coupled to the housing and configured to receive communications data, the I/O circuit being configured to couple the received communications data to the portable electronics device.

2. The device as specified in claim 1 wherein the housing includes an input connector configured to couple to the I/O circuit.

3. The device as specified in claim 2 wherein the power converter circuitry is disposed in the housing.

4. The device as specified in claim 1 further comprising an output connector configured to receive both the converted power and the communications data from the I/O circuit.

5. The device as specified in claim 4 further comprising a cord configured to couple to the output connector.

6. The device as specified in claim 5 wherein the cord is configured to communicate both the converted power and the communications data to the portable electronic device.

7. The device as specified in claim 6 further comprising a device connector configured to couple to the cord and the portable electronic device.

8. The device as specified in claim 7 wherein the device connector is configured to program a voltage of the converted power.

9. The device as specified in claim 8 wherein the device connector is a tip.

10. The device as specified in claim 2 wherein the input connector is an expansion slot.

11. The device as specified in claim 2 wherein the I/O circuit is configured to be selectively inserted into the expansion slot.

12. The device as specified in claim 11 wherein the I/O circuit is configured as a card.

13. The device as specified in claim 1 wherein the I/O circuit is configured to convert the received communications data from one format to another format.

14. The device as specified in claim 13 wherein the I/O circuit provides connectivity selected from the group consisting of: Ethernet, modem, 802.11, Bluetooth, and storage/memory.

15. The device as specified in claim 1 wherein the I/O circuit is configured to be powered by power provided by the power converter.

16. The device as specified in claim 1 further comprising a wireless communication device configured to wirelessly communicate the communications data to the portable electronics device.

17. The device as specified in claim 16 wherein the wireless communication device comprises a Blue Tooth transceiver.
